(19) United States
(12) Patent Application Publication
(10) Pub. No.: US 2019/0191170 A1
(43) Pub. Date: Jun. 20, 2019

(54) SYSTEM AND METHOD FOR IMPROVING EFFICIENCY IN ENCODING/DECODING A CURVED VIEW VIDEO

(71) Applicant: SZ DJI TECHNOLOGY CO., LTD., Shenzhen (CN)

(72) Inventors: Wenjun ZHAO, Shenzhen (CN); Xiaozhen ZHENG, Shenzhen (CN)

(21) Appl. No.: 16/283,420

(22) Filed: Feb. 22, 2019

Related U.S. Application Data
(63) Continuation of application No. PCT/CN2016/096434, filed on Aug. 23, 2016.

(51) Int. Cl. H04N 19/159; H04N 19/563; H04N 19/176; H04N 19/124

(52) U.S. Cl. CPC H04N 19/159; H04N 19/124; H04N 19/176; H04N 19/563

(57) ABSTRACT

A method for video decoding includes obtaining a mapping that corresponds a set of image regions in a first decoded image frame to at least a portion of a curved view, determining a padding scheme for the first decoded image frame based on the mapping, and constructing an extended image for the first decoded image frame according to the padding scheme. The extended image comprises one or more padding pixels. The method further includes using the extended image as a reference frame to obtain a second decoded image frame.

### CROSS-REFERENCE TO RELATED APPLICATION

This application is a continuation of International Application No. PCT/CN2016/096434, filed on Aug. 23, 2016, the entire contents of which are incorporated herein by reference.

### FIELD OF THE DISCLOSURE

The disclosed embodiments relate generally to video processing, more particularly, but not exclusively, to video encoding and decoding.

### BACKGROUND

The consumption of video content has been surging in recent years, mainly due to the prevalence of various types of portable, handheld, or wearable devices. For example, the virtual reality (VR) or augmented reality (AR) capability can be integrated into different head mount devices (HMDs). As the form of video content become more sophisticated, the storage and transmission of the video content become ever more challenging. For example, there is a need to reduce the bandwidth for video storage and transmission. This is the general area that embodiments of the disclosure are intended to address.

### SUMMARY

Described herein are systems and methods that can decode a curved view video. A decoder can obtain a mapping that corresponds a set of image regions in a decoded image frame to at least a portion of a curved view, and determine a padding scheme for the decoded image frame based on the mapping. Then, the decoder can construct an extended image for the decoded image frame according to the padding scheme, wherein the extended image comprises one or more padding pixels, and use the extended image as a reference frame to obtain another decoded image frame.

Also described herein are systems and methods that can encode a curved view video. An encoder can prescribe a padding scheme based on a mapping that corresponds a set of image regions in an encoding image frame to at least a portion of a curved view. Furthermore, the encoder can use the padding scheme to extend the set of image regions with one or more padding pixels. Then, the encoder can use using an extended encoding image with the one or more padding pixels to encode the encoding image frame.

### BRIEF DESCRIPTION OF DRAWINGS

FIG. 1 illustrates coding/compressing a curved view video, in accordance with various embodiments of the present disclosure.

FIG. 2 illustrates an exemplary equirectangular projection that can map a three dimensional spherical view to a two-dimensional plane, in accordance with various embodiments of the present disclosure.

FIG. 3 illustrates an exemplary cubic face projection that maps a three dimensional spherical view to a two-dimensional layout, in accordance with various embodiments of the present disclosure.

FIG. 4A-B illustrates different continuity relationships for various cubic faces when different mappings are applied, in accordance with various embodiments of the present disclosure.

FIG. 5 illustrates mapping a curved view into a two-dimensional (2D) image, in accordance with various embodiments of the present disclosure.

FIG. 6 illustrates using a padding scheme for providing additional continuity to improve coding efficiency, in accordance with various embodiments of the present disclosure.

FIGS. 7-10 illustrate exemplary padding schemes for various cubic face layouts, in accordance with various embodiments of the present disclosure.

FIG. 11 illustrates using a padding scheme for improving efficiency in video encoding, in accordance with various embodiments of the present disclosure.

FIG. 12 illustrates a flow chat for using a padding scheme for improving efficiency of curved view video encoding, in accordance with various embodiments of the present disclosure.

FIG. 13 illustrates using a padding scheme for improving efficiency in decoding a curved view video, in accordance with various embodiments of the present disclosure.

FIG. 14 illustrates a flow chat for using a padding scheme to improving efficiency of curved view video decoding, in accordance with various embodiments of the present disclosure.

### DETAILED DESCRIPTION

The disclosure is illustrated, by way of example and not by way of limitation, in the figures of the accompanying drawings in which like references indicate similar elements. It should be noted that references to “an” or “one” or “some” embodiment(s) in this disclosure are not necessarily to the same embodiment, and such references mean at least one.

In accordance with various embodiments of the present disclosure, the system can reduce the bandwidth requirement for storing and transmitting a curved view video. For example, a curved view can be a view projected on any smooth surface, such as a spherical surface or an ellipsoidal surface. A curved view video (or otherwise may be referred to as a 360° paranormal view video) can comprise a plurality of image frames in which the views in multiple directions are captured at the same time. Thus, a curved view video can cover a wide field of view (FOV). For example, a spherical view video (or a 360 degree paranormal view video) can include a sequence of frames covering a three-dimensional (3D) spherical FOV. In some embodiments, a spherical view video can have a 360 degree horizontal field of view (FOV), and a 180 degree vertical FOV. In some embodiments, a spherical view video can have a 360 degree horizontal FOV, and a 360 degree vertical FOV. The description of the disclosure as following uses a spherical view as example for a curved view. It will be apparent to those skilled in the art that other types of curved view can be used without limitation.

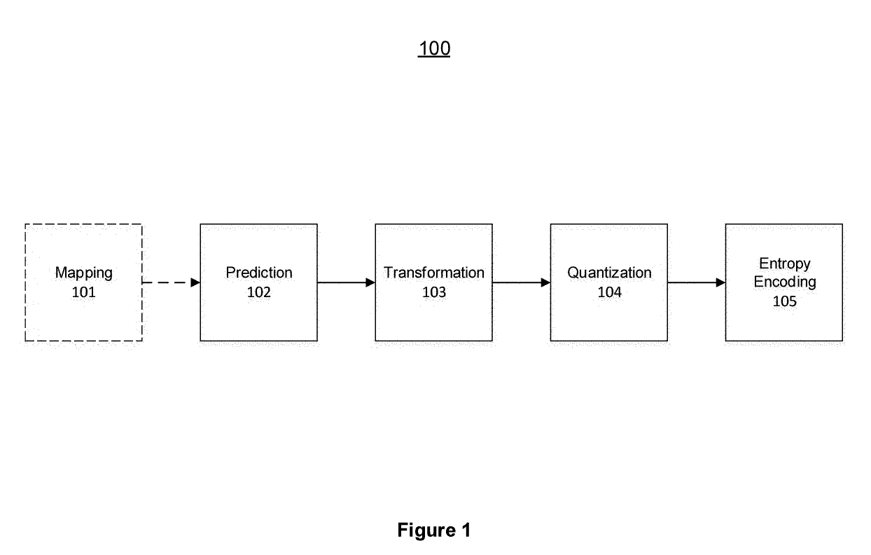

FIG. 1 illustrates coding/compressing a curved view video, in accordance with various embodiments of the present disclosure. As shown in FIG. 1, the coding/compressing of a curved view video can involve multiple steps, such as mapping 101, prediction 102, transformation 103, quantization 104, and entropy encoding 105.

In accordance with various embodiments, at the mapping step 101, the system can project a three dimensional (3D) curved view in a video sequence on a two-dimensional (2D) plane in order to take advantage of various video coding/compressing techniques. The system can use a two-dimensional rectangular image format for storing and transmitting the curved view video (e.g. a spherical view video). Also, the system can use a two-dimensional rectangular image format for supporting the digital image processing and performing codec operations.

Different approaches can be employed for mapping a curved view, such as a spherical view, to a rectangular image. For example, a spherical view can be mapped to a rectangular image based on an equirectangular projection. In some embodiments, an equirectangular projection can map meridians to vertical straight lines of constant spacing and can map circles of latitude to horizontal straight lines of constant spacing. Alternatively, a spherical view can be mapped into a rectangular image based on cubic face projection. A cubic face projection can approximate a 3D sphere surface based on its circumscribed cube. The projections of the 3D sphere surface on the six faces of the cube can be arranged as a 2D image using different cubic face layouts, which defines cubic face arrangements such as the relative position and orientation of each individual projection. Apart from the equirectangular projection and the cubic face projection as mentioned above, other projection mechanisms can be exploited for mapping a 3D curved view into a 2D video. A 2D video can be compressed, encoded, and decoded based on some commonly used video codec standards, such as HEVC/H.265, H.264/AVC, AVS1-P2, AVS2-P2, VP8, VP9.

In accordance with various embodiments, the prediction step 102 can be employed for reducing redundant information in the image. The prediction step 102 can include intra-frame prediction and inter-frame prediction. The intra-frame prediction can be performed based solely on information that is contained within the current frame, independent of other frames in the video sequence. Inter-frame prediction can be performed by eliminating redundancy in the current frame based on a reference frame, e.g. a previously processed frame.

For example, in order to perform motion estimation for inter-frame prediction, a frame can be divided into a plurality of image blocks. Each image block can be matched to a block in the reference frame, e.g. based on a block matching algorithm. In some embodiments, a motion vector, which represents an offset from the coordinates of an image block in the current frame to the coordinates of the matched image block in the reference frame, can be computed. Also, the residuals, i.e. the difference between each image block in the current frame and the matched block in the reference frame, can be computed and grouped.

Furthermore, the redundancy of the frame can be eliminated by applying the transformation step 103. In the transformation step 103, the system can process the residuals for improving coding efficiency. For example, transformation coefficients can be generate by applying a transformation matrix and its transposed matrix on the grouped residuals. Subsequently, the transformation coefficients can be quantized in a quantization step 104 and coded in an entropy encoding step 105. Then, the bit stream including information generated from the entropy encoding step 105, as well as other encoding information (e.g., intra-frame prediction mode, motion vector) can be stored and transmitted to a decoder.

At the receiving end, the decoder can perform a reverse process (such as entropy decoding, dequantization and inverse transformation) on the received bit stream to obtain the residuals. Thus, the image frame can be decoded based on the residuals and other received decoding information. Then, the decoded image can be used for displaying the curved view video.

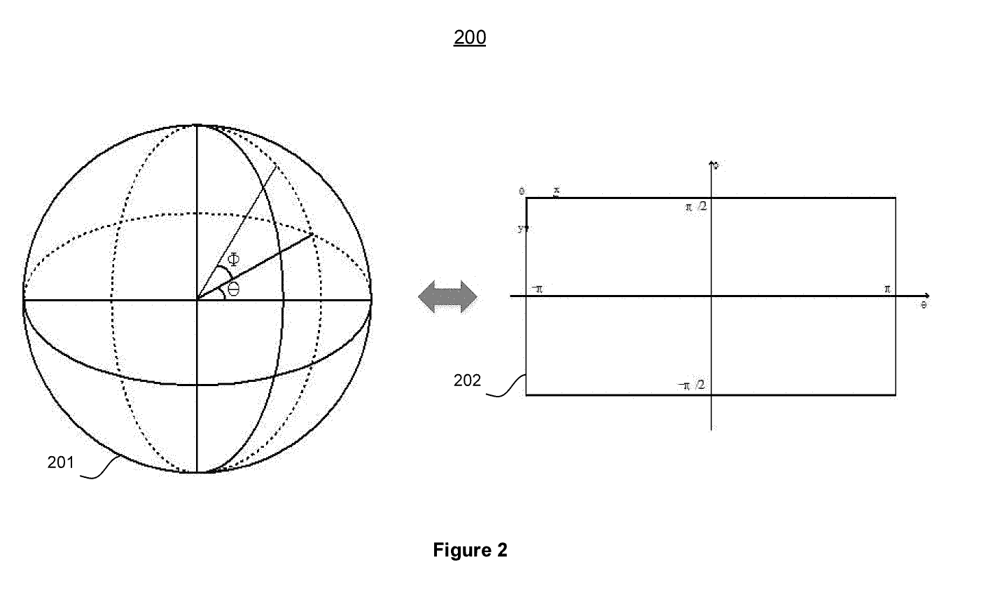

FIG. 2 illustrates an exemplary equirectangular projection that can map a three dimensional spherical view to a two-dimensional plane, in accordance with various embodiments of the present disclosure. As shown in FIG. 2, using an equirectangular projection, the sphere view 201 can be mapped to a two-dimensional rectangular image 202. On the other hand, the two-dimensional rectangular image 202 can be mapped back to the sphere view 201 in a reverse fashion.

In some embodiments, the mapping can be defined based on the following equations.

x=λ cos φ₁ (Equation 1)

y=φ (Equation 2)

Wherein x denotes the horizontal coordinate in the 2D plane coordinate system, and y denotes the vertical coordinate in the 2D plane coordinate system 101. A denotes the longitude of the sphere 100, while φ denotes the latitude of the sphere. λ denotes the standard parallels where the scale of the projection is true. In some embodiments, φ₁ can be set as 0, and the point (0, 0) of the coordinate system 101 can be located in the center.

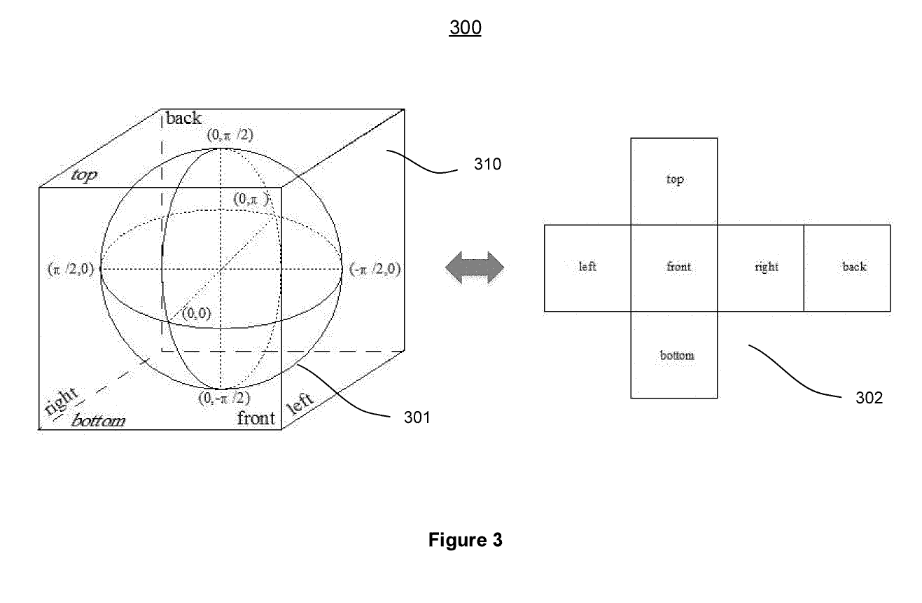

FIG. 3 illustrates an exemplary cubic face projection that maps a three dimensional spherical view to a two-dimensional layout, in accordance with various embodiments of the present disclosure. As shown in FIG. 3, using a cubic face projection, a sphere view 301 can be mapped to a two-dimensional layout 302. On the other hand, the two-dimensional layout 302 can be mapped back to the sphere view 301 in a reverse fashion.

In accordance with various embodiments, the cubic face projection for the spherical surface 301 can be based on a cube 310, e.g. a circumscribed cube of the sphere 301. In order for ascertaining the mapping relationship, ray casting can be performed from the center of the sphere to obtain a number of pairs of intersection points on the spherical surface and on the cubic faces respectively.

As shown in FIG. 3, an image frame for storing and transmitting a spherical view can include six cubic faces of the cube 310, e.g. a top cubic face, a bottom cubic face, a left cubic face, a right cubic face, a front cubic face, and a back cubic face. These six cubic faces may be expanded on (or projected to) a 2D plane.

It should be noted that the projection of a curved view such as a spherical view or an ellipsoidal view based on cubic face projection is provided for the purposes of illustration, and not intended to limit the scope of the present disclosure. For persona having ordinary skills in the art, various modifications and variations can be conducted under the teachings of the present disclosure Exemplary embodiments of projection formats for the projection pertaining to the present disclosure may include octahedron, dodecahedron, icosahedron, or any polyhedron. For example, the projections on eight faces may be generated for an approximation based on an octahedron, and the projections on those eight faces can be expanded and/or projected onto a 2D plane. In another example, the projections on twelve faces may be generated for an approximation based on a dodecahedron, and the projections on those twelve faces can be expanded and/or projected onto a 2D plane. In yet another example, the projections on twenty faces may be generated for an approximation based on an icosahedron, and the projections on those twenty faces can be expanded and/or projected onto a 2D plane. In yet another example, the projections of an ellipsoidal view on various faces of a polyhedron may be generated for an approximation of the ellipsoidal view, and the projections on those twenty faces can be expanded and/or projected onto a 2D plane.

It still should be noted that the cubic face layout illustrated in FIG. 3, the different cubic faces can be depicted using its relative position, such as a top cubic face, a bottom cubic face, a left cubic face, a right cubic face, a front cubic face, and a back cubic face. Such depiction is provided for the purposes of illustration only, and not intended to limit the scope of the present disclosure. For persona having ordinary skills in the art, various modifications and variations can be conducted under the teachings of the present disclosure.

In accordance with various embodiments, depending on the orientation or relative position of each cubic face, the continuous relationship among various cubic faces can be represented using different continuity relationships.

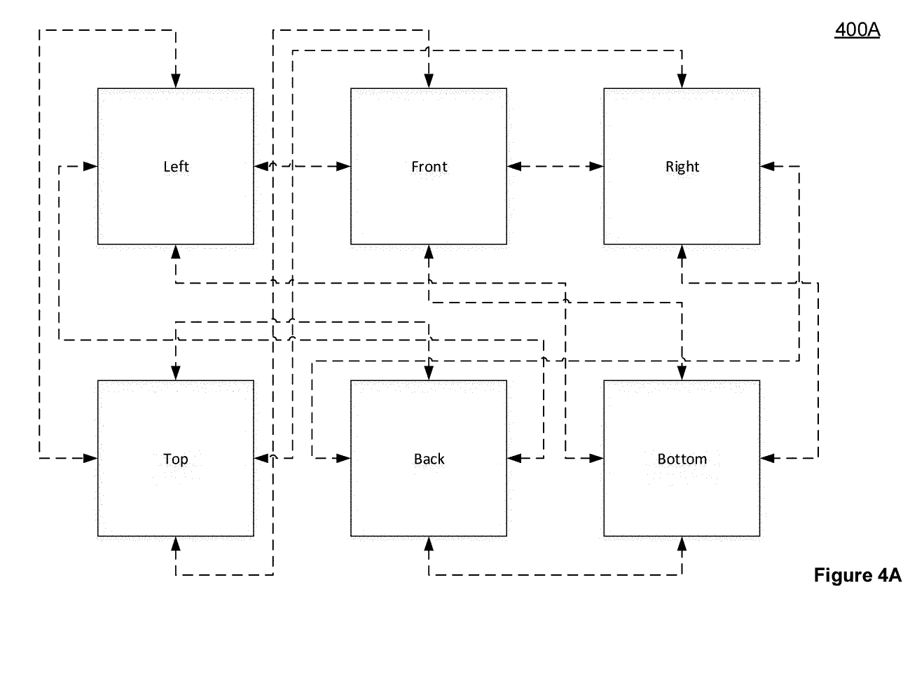

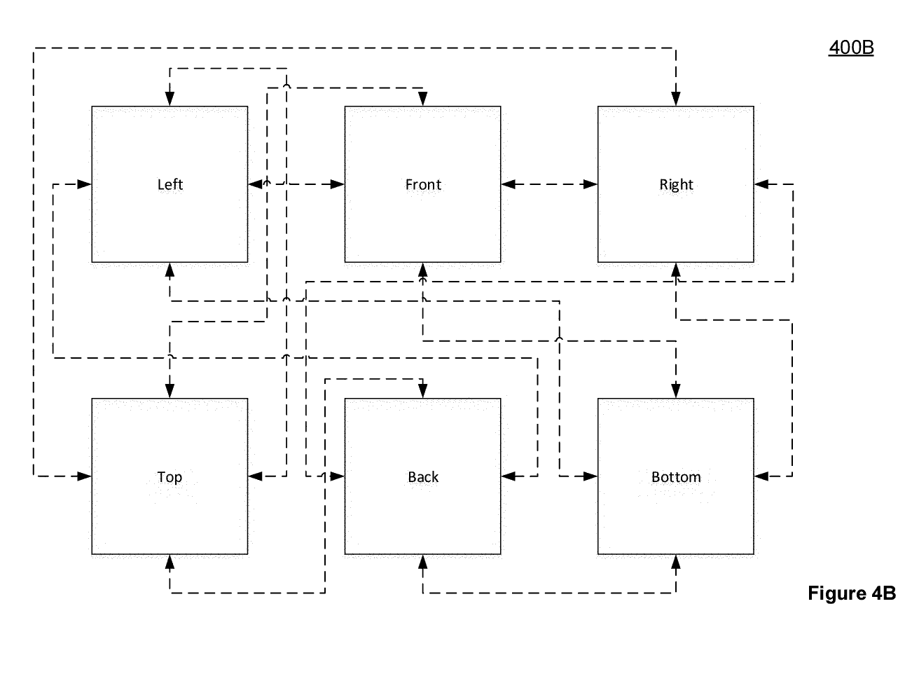

FIG. 4A-B illustrates different continuity relationships for various cubic faces when different mappings are applied, in accordance with various embodiments of the present disclosure. As shown in FIG. 4A-B, different continuity relationships 400A and 400B can be used for representing the different continuous relationship among various cubic faces, when the orientation of the top cubic face is altered.

Referring to FIG. 4A, the following continuous relationship can be observed. The left portion of the left cubic face is continuous with the right portion of the back cubic face, the right portion of the left cubic face is continuous with the left portion of the front cubic face, the right portion of the front cubic face is continuous with the left portion of the right cubic face, the upper portion of the front cubic face is continuous with the upper portion of the top cubic face, the lower portion of the front cubic face is continuous with lower portion of the bottom cubic face, the right portion of the right cubic face is continuous with the left portion of the back cubic face, the left portion of the top cubic face is continuous with the upper portion of the left cubic face, the right portion of the top cubic face is continuous with the upper portion of the right cubic face, the upper portion top cubic face is continuous with the upper portion of the back cubic face, the left portion of the bottom cubic face is continuous with the lower portion of the left cubic face, the right portion of the bottom cubic face is continuous with the lower portion of the right cubic face, the lower portion of the bottom cubic face is continuous with the lower portion of the back cubic face.

Referring to FIG. 4B, the following continuous relations can be observed, when the front cubic face is oriented differently. The left portion of the left cubic face is continuous with the right portion of the back cubic face, the right portion of the left cubic face is continuous with the left portion of the front cubic face, the right portion of the front cubic face is continuous with the left portion of the right cubic face, the upper portion of the front cubic face is continuous with the upper portion of the top cubic face, the lower portion of the front cubic face is continuous with upper portion of the bottom cubic face, the right portion of the right cubic face is continuous with the left portion of the back cubic face, the left portion of the top cubic face is continuous with the upper portion of the right cubic face, the right portion of the top cubic face is continuous with the upper portion of the left cubic face, the lower portion top cubic face is continuous with the upper portion of the back cubic face, the left portion of the bottom cubic face is continuous with the lower portion of the left cubic face, the right portion of the bottom cubic face is continuous with the lower portion of the right cubic face, the lower portion of the bottom cubic face is continuous with the lower portion of the back cubic face.

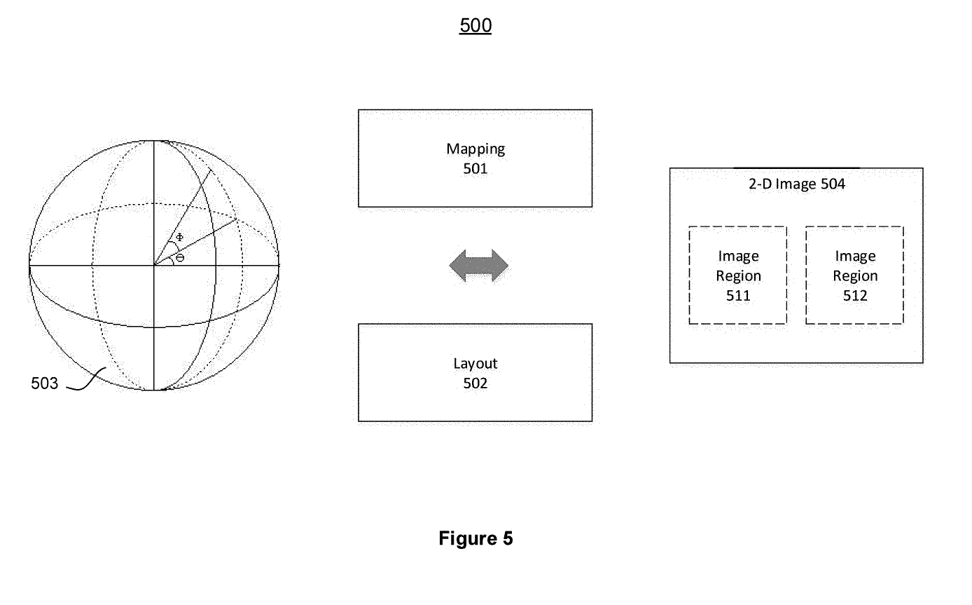

FIG. 5 illustrates mapping a curved view into a two-dimensional (2D) image, in accordance with various embodiments of the present disclosure. As shown in FIG. 5, a mapping 501 can be used for corresponding a curved view 503 to a 2D image 504. The 2D image 504 can comprise a set of image regions 511-512, each of which contains a portion of the curved view 503 projected on a face of a polyhedron (e.g. a cube).

In accordance with various embodiments, the set of image regions can be obtained by projecting the at least a portion of the curved view to a plurality of faces on a polyhedron. For example, a spherical view 503 can be projected from a spherical surface, or a portion of a spherical surface, to a set of cubic faces. In a similar fashion, a curved view can be projected from an ellipsoid surface, or a portion of an ellipsoid surface, to a set of rectangular cubic surfaces.

Furthermore, a curved view, e.g. a spherical view 503, can be mapped into a two-dimensional rectangular image 504 based on different layouts. As shown in FIG. 5, the set of image regions 511-512 can be arranged in the 2-D image 504 based on a layout 502, which defines the relative positional information, such as location and orientation, of the image regions 511-512 in the 2-D image.

As shown in FIG. 5, the spherical view 503 is continuous on every direction. In accordance with various embodiments, a set of image regions 511-512 can be obtained by projecting at least a portion of the curved view 503 to a plurality of faces on a polyhedron. The continuous relationship can be represented using a continuity relationship, which is pertinent to a particular mapping 501 and layout 502. Due to the geometry limitation, the two-dimensional image 504 may not be able to fully preserve the continuity in the spherical view 503.

In accordance with various embodiments, the system can employ a padding scheme for providing or preserving the continuity among the set of image regions 511-512 in order to improve the efficiency in encoding/decoding a spherical view video.

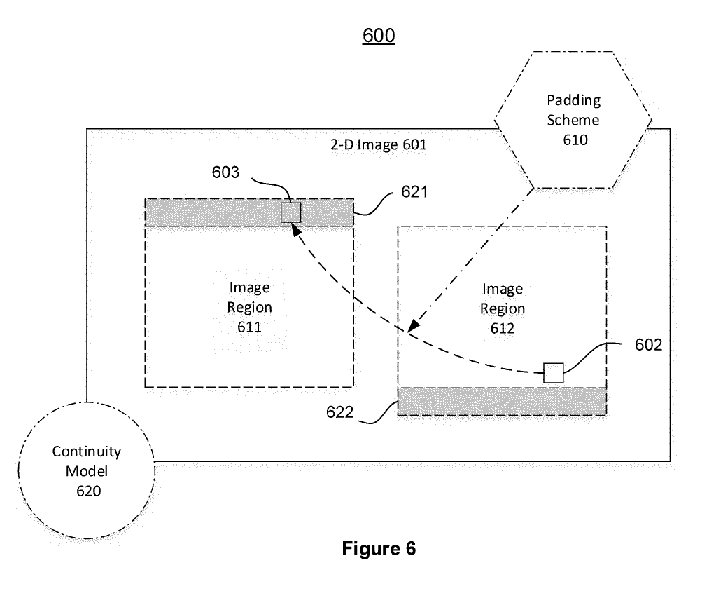

FIG. 6 illustrates using a padding scheme for providing additional continuity to improve coding efficiency, in accordance with various embodiments of the present disclosure. As shown in FIG. 6, a 2-D image 601 can comprise a set of image regions, such as image regions 611-612. The 2-D image 601 corresponds to at least a portion of a curved view, and the set of image regions 611-612 can be related to each other based on a continuity relationship 620.

In accordance with various embodiments, a padding scheme 601 can be employed for providing or preserving continuity among the set of image regions. For example, due to the layout of image regions 611-612, a continuity may be lost at the top boundary of the image region 611 and the bottom boundary of image region 612. In order to preserve such continuity, as shown in FIG. 6, a padding zone 621 can be used for extending the image region 611 at its top boundary. For example, the system can identify a reference pixel 602 in the image region 612, and assign the value of the reference pixel to a padding pixel 603 in the padding zone 621 for image region 611. Similarly, a padding zone 622 can be used for extending the image region 612 at its bottom boundary.

In accordance with various embodiments, the padding pixels can be arranged to wrap around the set of image regions as a group in the 2-D image frame 601. Alternatively, the padding pixels can be arranged in an area surrounding individual or a subset of the image regions 611-612 within the image frame 601. Additionally, the padding pixels can be arranged in manner that is a combination thereof.

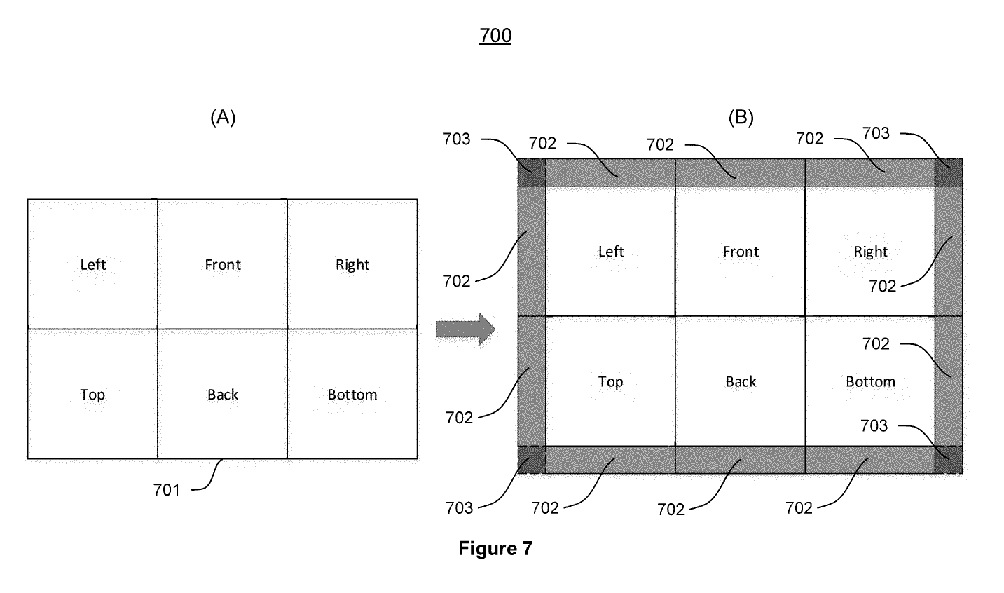

FIGS. 7-10 illustrate exemplary padding schemes for various cubic face layouts, in accordance with various embodiments of the present disclosure.

As shown in FIG. 7A, a two-dimensional image 701 corresponding to a spherical view can have six cubic faces, which can be arranged in two rows, with the “Left”, “Front”, and “Right” faces in a row, and the “Top”, “Back”, and “Bottom” faces in another row 700. In order to improve coding efficiency, a padding scheme 700 can be applied on the two-dimensional image 701 based on the continuity relationship as shown in FIG. 4B.

As shown in FIG. 7B, the padding pixels 702 may be attached to (or extended from) the left boundary and the upper boundary of the left cubic face; the upper boundary of the front cubic face; the upper boundary and the right boundary of the right cubic face; the left boundary and the lower boundary of the top cubic face; the lower boundary of the back cubic face; and the right boundary and the lower boundary of the bottom cubic face. The number of padding pixel 702 for each different padding region can be different. For example, a portion of a cubic face or even a whole image face can be used for padding purpose.

In some embodiments, various padding operations can be performed based on the padding scheme 700 to approximate a sphere view in a video. For example, a padding operation can involve copying or stitching the pixels in a reference region (e.g., in a first cubic face) to a padding region (e.g., at a boundary of a second cubic face). It should be noted that the padding scheme described above and below is provided merely for the purposes of illustration, and not intended to limit the scope of the present disclosure.

For example, based on the continuity relationship as shown in FIG. 4B, the pixels in the right portion of the back cubic face can be copied and stitched to the left boundary of the left cubic face. The pixels in the left portion of the front cubic face can be copied and stitched to the right boundary of the left cubic face. The pixels in the left portion of the right cubic face can be copied and stitched to the right boundary of the front cubic face. The pixels in the upper portion of the top cubic face can be copied and stitched to the upper boundary of the front cubic face. The pixels in the upper portion of the bottom cubic face can be copied and stitched to the lower boundary of the front cubic face. The pixels in the left portion of the back cubic face can be copied and stitched to the right boundary of the right cubic face. The pixels in the upper portion of the right cubic face can be copied and stitched to the left boundary of the top cubic face. The pixels in the upper portion of the left cubic face can be copied and stitched with the right boundary of the top cubic face. The pixels in the upper portion of the back cubic face can be copied and stitched to the low boundary of the top cubic face. The pixels in the lower portion of the left cubic face can be copied and stitched to the left boundary of the bottom cubic face. The pixels in the lower portion of the right cubic face can be copied and stitched to the right boundary of the bottom cubic face. The pixels in the lower portion of the back cubic face can be copied and stitched to the lower boundary of the bottom cubic face.

Also as shown in FIG. 7B, the padding schemes 700 can involve additional padding pixels, such as the corner pixels 703, which can be used for maintaining the rectangular format of the extended image (along with the padding pixels 702). In accordance with various embodiments, various scheme can be used for assigning values to the corner pixels 703. The system can assign a predetermined value to each corner pixels 703 in the extended image. For example, the predetermined value can be based on a value of 0, 2^{N-}1, or 2^{N-1} (with N as the bit depth of the image), or a preset value described in the encoder and decoder syntax. Additionally, the predetermined value can be a replicated value of a corresponding pixel within the two-dimensional image 701. For example, the corresponding corner pixel can be a corner pixel determined based on the continuity relationship (i.e., a different corner pixel may be selected when a different continuity relationship is applied).

Based on the continuity relationship as shown in FIG. 4B, the padding pixels in the upper left corner region of the extended image can be assigned with the values of the reference pixels at the upper left corner of the left cubic face, the values of the reference pixels at the upper right corner of the back cubic face, or the values of the reference pixels at the upper right corner of top cubic face in the image 701; the padding pixels in the upper right corner region of the extended image can be assigned with the values of the reference pixels at the upper right corner of the right cubic face, the values of the reference pixels at the upper left corner of the back cubic face, or the values of the reference pixels at the upper left corner of top cubic face in the image 701; the padding pixels in the lower left corner region of the extended image can be assigned with the values of the reference pixels at the lower left corner of the top cubic face, the values of the reference pixels at the upper right corner of the right cubic face, or the values of the reference pixels at the upper left corner of the back cubic face in the image 701; and the padding pixels in the lower right corner region of the extended image can be assigned with the values of the reference pixels at the lower right corner of the bottom cubic face, the values of the reference pixels at the lower right corner of the right cubic face, or the values of the reference pixels at the lower left corner of bottom cubic face in the image 701.

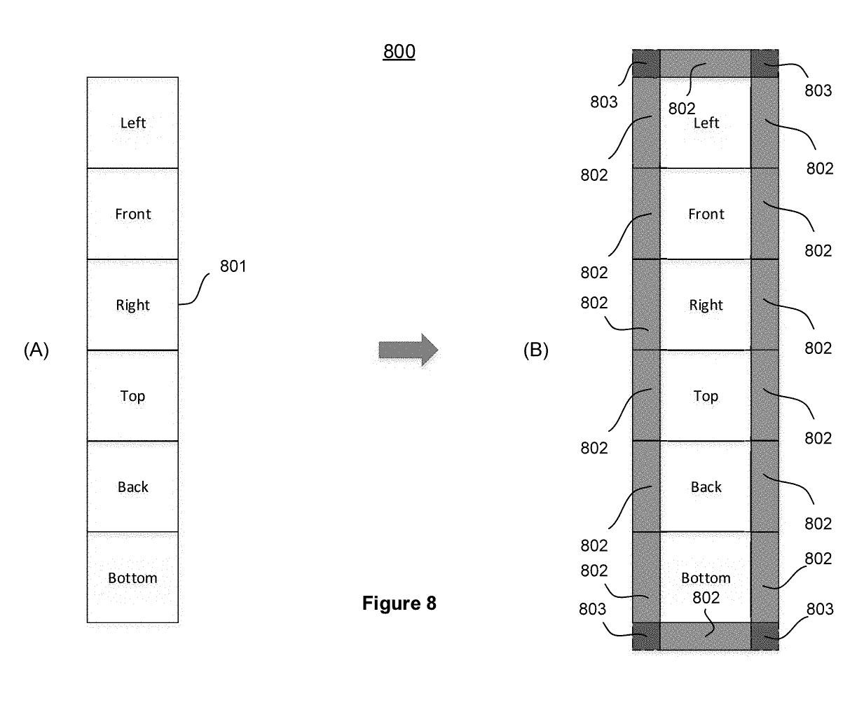

As shown in the FIG. 8A, a two-dimensional image 801 corresponding to a spherical view can have six cubic faces, which can be arranged in a vertical column 800. As shown in the FIG. 8B, the padding can be performed on the left boundary, the right boundary and the upper boundary of the left cubic face, on the left boundary and the right boundary of the front cubic face, on the left boundary and the right boundary of the right cubic face, on the left boundary and the right boundary of the top cubic face, on the left boundary and the right boundary of the back cubic face, on the left boundary, the right boundary and the lower boundary of the bottom cubic face.

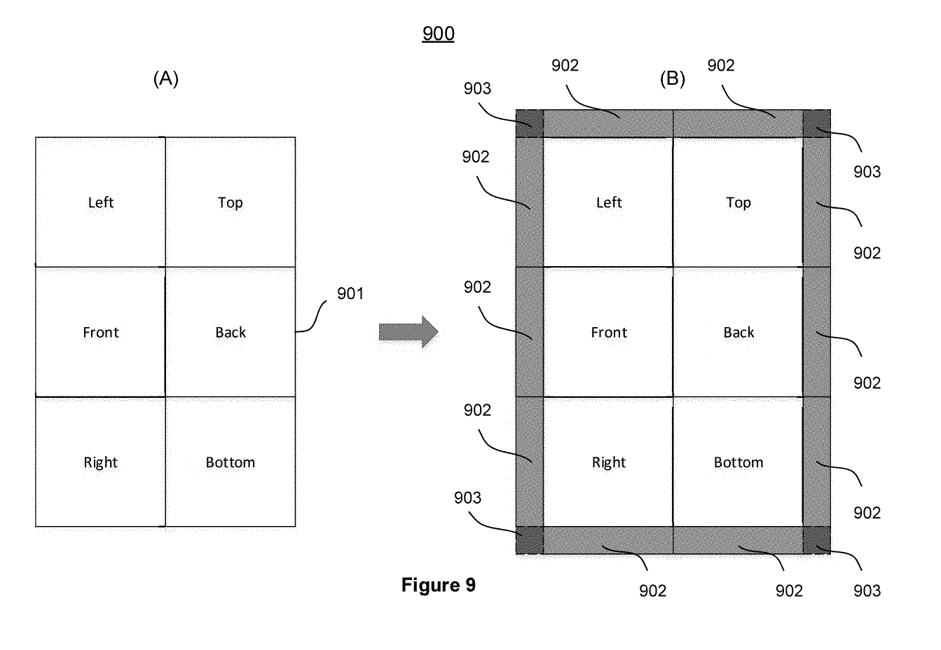

As shown in the FIG. 9A, a two-dimensional image 901 corresponding to a spherical view can have six cubic faces, which can be arranged in two columns 900. As shown in the FIG. 9B, the padding can be performed on the left boundary and the upper boundary of the left cubic face, on the upper boundary and the right boundary of the top cubic face, on the left boundary of the front cubic face, on the right boundary of the back cubic face, on the left boundary and the lower boundary of the right cubic face, on the right boundary and the lower boundary of the bottom cubic face.

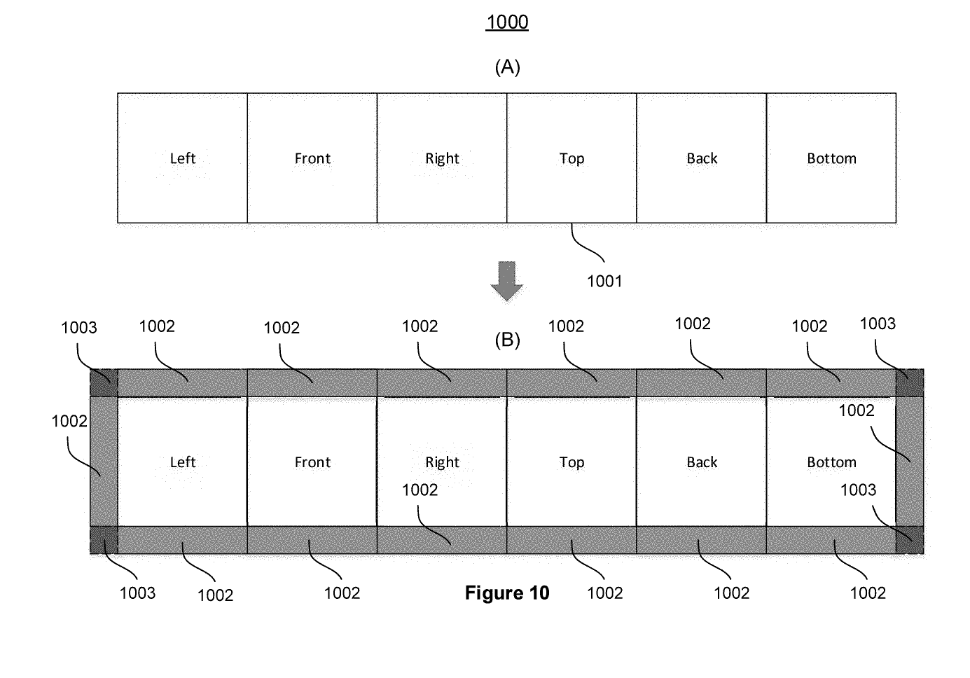

As shown in the FIG. 10A, a two-dimensional image 1001 corresponding to a spherical view can have six cubic faces, which can be arranged in a horizontal line 1000. As shown in the FIG. 10B, the padding can be performed on the left boundary, the upper boundary and the lower boundary of the left cubic face, on the upper boundary and the lower boundary of the front cubic face, on the upper boundary and the lower boundary of the right cubic face, on the upper boundary and the lower boundary of the top cubic face, on the upper boundary and the lower boundary of the back cubic face, on the right boundary, the upper boundary and the lower boundary of the bottom cubic face.

Also as shown in FIG. 8B-10B, the padding schemes 800-1000 can involve additional padding pixels, such as corner pixels 803-1003, which can be used for maintaining the rectangular format of the extended image along with the padding pixels 802-1002. In accordance with various embodiments, various scheme can be used for assigning values to the corner pixels 803-1003. For example, the system can assign a predetermined value to each corner pixels 803-1003 in the extended image, in a similar manner as discussed above in FIG. 7B.

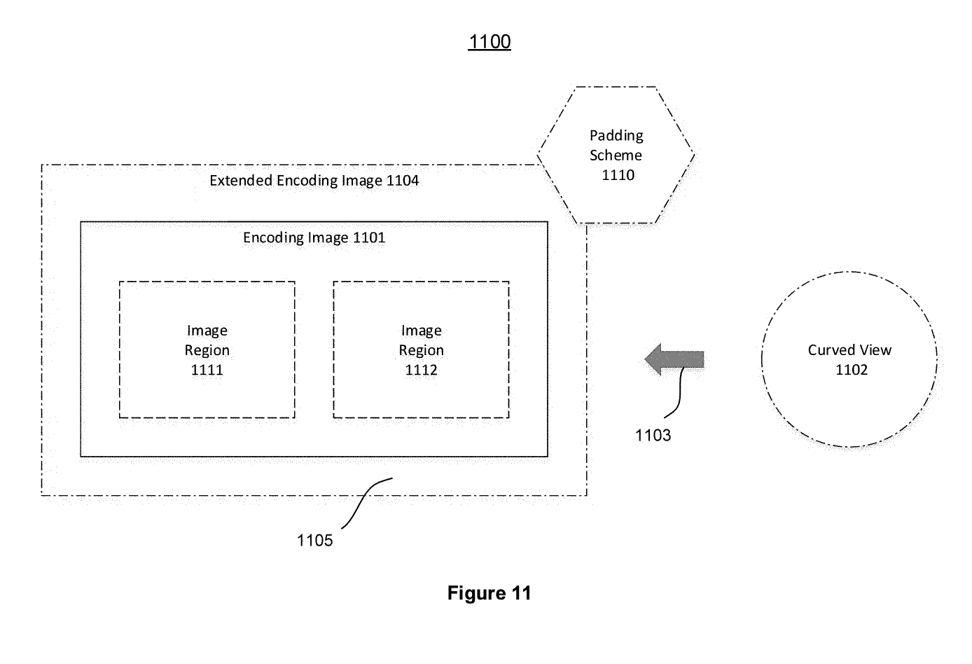

FIG. 11 illustrates using a padding scheme for improving efficiency in video encoding, in accordance with various embodiments of the present disclosure. As shown in FIG. 11, an encoder can prescribe a padding scheme 1110 based on a mapping 1103 that corresponds a set of image regions 1111-1112 in an encoding image frame 1101 to at least a portion of a curved view 1102. The encoding image frame 1101 can be a rectangular image. Additionally, using the cubic face projection, each individual image region 1111-1112 can also be a rectangular region. Otherwise, the individual image regions 1111-1112 can be in different shapes when different types of projections are used.

In accordance with various embodiments, the encoder can use the padding scheme 1110 to extend the set of image regions 1111-1112 in the encoding image frame 1101 with one or more padding pixels (i.e. construct an extended encoding image 1104). The encoder can determine one or more reference pixels in the set of image regions 1111-1112 in the encoding image frame 1101 based on the padding scheme 1110. Then, the encoder can assign values of the one or more reference pixels in the set of image regions 1111-1112 to the one or more padding pixels. Additionally, the encoder can assign one or more predetermined values to one or more additional padding pixels in the extended encoding image 1104. For example, the additional padding pixels can be arranged in the corner regions of the extended encoding image 1104, such as the corner pixels 703, 803, 903, and 1003 in the extended image 702, 802, 902, and 1002 as shown in the above FIGS. 7B-10B. Thus, the encoder can provide or preserve additional continuity, which can be beneficial in performing intra-frame prediction and inter-frame prediction in the encoding process.

In accordance with various embodiments, the encoder can store the extended image in a picture buffer. For example, the extended encoding image 1104 can be stored in a reference picture buffer and/or a decoded picture buffer (DPB). Thus, the extended encoding image 1104 can be utilized for both intra-frame prediction and inter-frame prediction.

In accordance with various embodiments, the encoder can use the extended encoding image 1104 with the padding pixels for encoding the encoding image frame 1101. For example, the encoder can use the padding pixels to perform intra-frame prediction for encoding the encoding image frame 1101. Also, the encoder can use the extended encoding image 1104 for performing inter-frame prediction in order to encode another encoding image frame in the video sequence. In some embodiments, each different encoding image frame may contain a different set of image regions that correspond to at least a portion of a different curved view. Additionally, the encoder can avoid encoding the padding pixels in the extended encoding image 1104; or clipping off the padding pixels from the extended encoding image 1104 based on the padding scheme 1110.

In accordance with various embodiments, for transmitting the encoded data to a decoder, the encoder can provide the mapping in the encoding information, e.g. the encoding mode information, associated with the encoding image 1101. Also, the system can provide the layout of the set of image regions 1111-1112 in the encoding information associated with the encoding image 1101. Thus, the padding scheme 1110 can be determined based on the mapping and layout of the set of image regions in the encoding image at the receiving end.

The following Table 1 is an exemplary syntax that can be stored in a header section associated with the encoded bit stream for providing the detailed padding information.

TABLE 1

| Syntax | Value |
|---|---|
| reference_frame_extension_syntax { | |
| num_of_layout_face_minus1; | 5 |
| num_of_boundary_each_face_minus1; | 3 |
| for(i=0;i<=num_of_layout_face_minus1;i++) { | |
| for(j=0;j<=num_of_boundary_each_face_minus1;j++) { | |
| need_extension; | 0/1 |
| if (need_extension==1) { | |
| index_of_layout_face; | 0~5 |
| index_of_boundary; | 0~3 |
| } | |
| } | |
| } | |
| } | |

For example, the encoding information can include an indicator (e.g. a flag) for each boundary of each the image region in the encoding image frame. The indicator indicates whether a boundary of an image region is padded with one or more padding pixels. Additionally, the encoding information can include other detailed information for performing the padding operations according to padding scheme 1110, such as the value of which pixel in the encoding image 1101 is to be copied or stitched to which padding pixel in the extended encoding image 1104.

Additionally, the encoding information can include the number of padding pixels, which can also be written into a header section for the transmitted bit stream. Alternatively, the encoding information can contain other information such as the number of rows and/or the number of columns of padding pixels at each boundary of the image region to be extended. Exemplary embodiments pertaining to the present disclosure may include sequence header, picture header, slice header, video parameter set (VPS), sequence parameter set (SPS), or picture parameter set (PPS), etc.

In the conventional two-dimensional video encoding process, the reference image maintained in the image buffer (e.g. the DPB) can be the same as or substantially similar to the encoding image or the inputting image.

Unlike the conventional two-dimensional video encoding process, in order for encoding a curved view video, an encoding image with padding (La the extended encoding image) can be used as a reference image for encoding one or more subsequent images in the video. In such a case, the extended encoding image can be maintained in the image buffer (e.g. the IAPB). Then, a clip operation can be applied on the extended encoding image in order to remove the padding. On the other hand, when the encoding image is not used as a reference image, there is no need for padding the encoding image. Thus, the encoding image can be encoded without further modification such as padding.

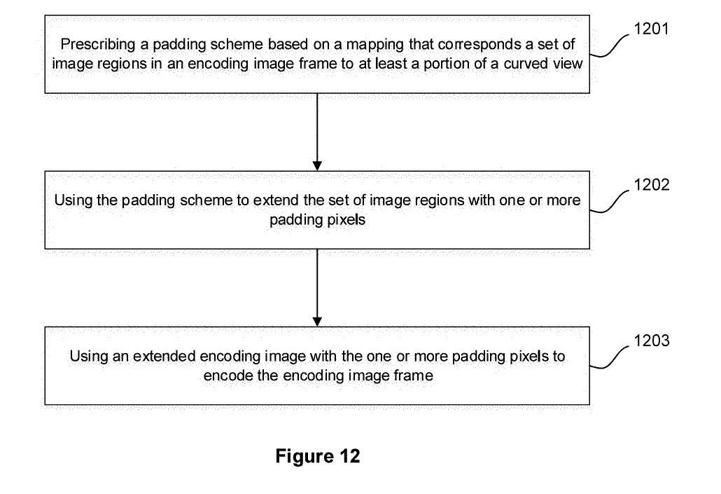

FIG. 12 illustrates a flow chat for using a padding scheme for improving efficiency of curved view video encoding, in accordance with various embodiments of the present disclosure.

As shown in FIG. 12, at step 1201, the system can prescribe a padding scheme based on a mapping that corresponds a set of image regions in an encoding image frame to at least a portion of a curved view. Then, at step 1202, the system can use the padding scheme to extend the set of image regions with one or more padding pixels. Furthermore, at step 1203, the system can use using an extended encoding image with the one or more padding pixels to encode the encoding image frame.

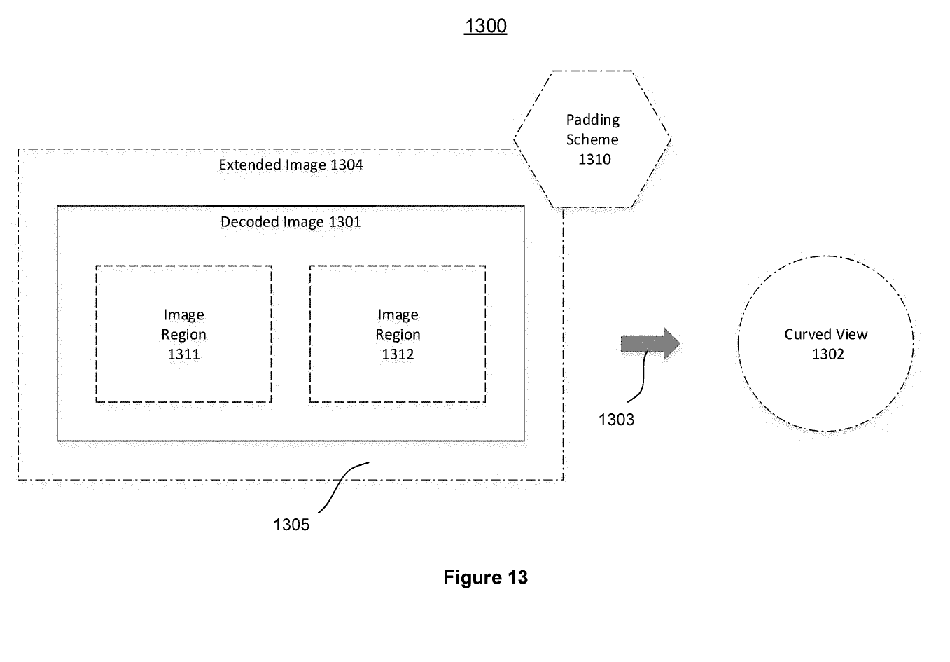

FIG. 13 illustrates using a padding scheme for improving efficiency in decoding a curved view video, in accordance with various embodiments of the present disclosure. As shown in FIG. 13, a decoder can obtain a mapping 1303 that corresponds a set of image regions 1311-1312 in a decoded image 1301 to at least a portion of a curved view 1302.

In accordance with various embodiments, the mapping 1303 can be retrieved from decoding information associated with the decoded image 1301. Also, the decoder can obtain a layout of the set of image regions 1311 in the decoded image 1301 from decoding information associated with the decoded image. Thus, the decoder can determine a padding scheme 1310 for the decoded image frame based on the mapping 1303.

The padding scheme 1310 can be defined based on the layout of the set of image regions 1311-1312 in the decoded image 1301. For example, the padding scheme 1310 can include an indicator (e.g. a flag) for each boundary of each the image region in the decoded image frame, wherein the indicator indicates whether a boundary of an image region is padded with one or more padding pixels.

In accordance with various embodiments, the decoding information can be stored in a header section in a bit stream received from an encoder. The decoder can be configured to receive the syntax (e.g. Table 1) for providing the detailed padding information. Thus, the decoder can be aware of the padding scheme, which is used by the encoder for encoding.

In accordance with various embodiments, the decoder can use the padding scheme 1310 to extend the set of image regions 1311-1312 in the decoded image 1301 with one or more padding pixels (i.e. construct an extended decoded image 1304). The decoder can determine one or more reference pixels in the set of image regions 1111-1112 in the decoded image 1301 based on the padding scheme 1310. Then, the decoder can assign values of the one or more reference pixels in the set of image regions 1311-1312 to the padding pixels.

In accordance with various embodiments, the padding pixels can be arranged at one or more boundaries of the decoded image 1301; or in an area surrounding one or more the image regions 1311-1312; or a combination thereof. Additionally, the decoder can assign one or more predetermined values to one or more additional padding pixels in the extended decoded image 1304. For example, the additional padding pixels can be arranged in the corner regions of the extended decoded image 1304, such as the corner pixels 703, 803, 903, and 1003 in the extended image 702, 802, 902, and 1002 as shown in the above FIGS. 7B-10B. Thus, the system can provide or preserve additional continuity, which can be beneficial in performing intra-frame prediction and inter-frame prediction in the encoding process.

In accordance with various embodiments, the system can render the at least a portion of the curved view by projecting the set of image regions 1311-1312 from a plurality of faces of a polyhedron to a curved surface. For example, the system can render a spherical view by projecting the set of image regions 1311-1312 from a plurality of faces of a cube to a spherical surface (i.e. the curved surface is a spherical surface and the polyhedron is a cube). In another example, the system can render a ellipsoidal view by projecting the set of image regions 1311-1312 from a plurality of faces of a rectangular cube to a ellipsoidal surface (i.e. the curved surface is an ellipsoidal surface and the polyhedron is a rectangular cube).

In accordance with various embodiments, the decoder can use one or more padding pixels to perform intra-frame prediction. For example, the value of one or more decoded pixel can be assigned to a padding pixel for decoding another pixel.

In accordance with various embodiments, the decoder can store the extended image 1304 in a picture buffer. Thus, the extended image 1304 can be used as a reference image for performing inter-frame prediction. Furthermore, the system can obtain the decoded image frame by clipping off the one or more padding pixels from the extended image based on the padding scheme. Then, system can output the decoded image frame for display.

In the conventional two-dimensional video decoding process, the reference image maintained in the image buffer (e.g. the DPB) can be the same as or substantially similar to the decoded image or the outputting image.

Unlike the conventional two-dimensional video decoding process, in order for decoding a curved view video, a decoded image with padding (.e. the extended decoded image) can be used as a reference image for decoding one or more subsequent images in the video. In such a case, the extended decoded image can be maintained in the image buffer (e.g. the DPB). Then, a clip operation can be applied on the extended decoded image in order to remove the padding and obtain the output image for display or storage. On the other hand, when the decoded image is not used as a reference image, there is no need for padding the decoded image. Thus, the decoded image can be output for display or storage without further modification such as padding.

In accordance with various embodiments, a curved view video may contain a sequence of images corresponding to a sequence of curved view. Furthermore, each different image in the sequence can contain a set of image regions associated with at least a portion of a different curved view.

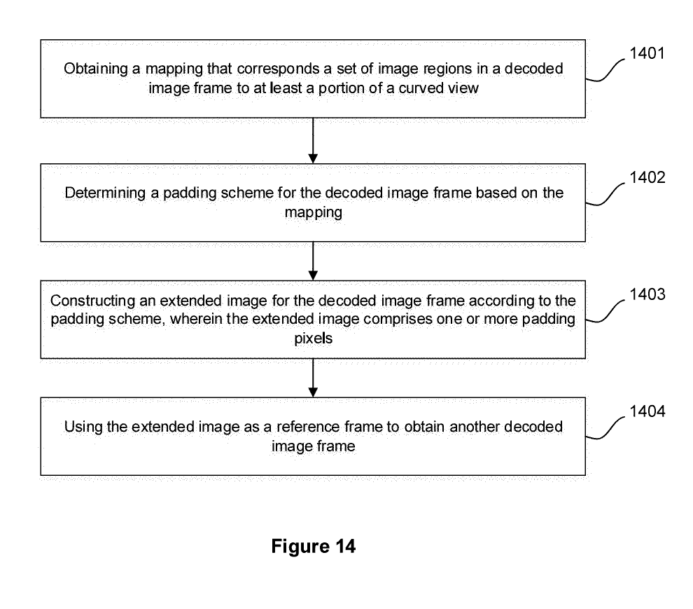

FIG. 14 illustrates a flow chat for using a padding scheme to improving efficiency of curved view video decoding, in accordance with various embodiments of the present disclosure. As shown in FIG. 14, at step 1401, the system can obtain a mapping that corresponds a set of image regions in a decoded image frame to at least a portion of a curved view. Then, at step 1202, the system can determine a padding scheme for the decoded image frame based on the mapping. Furthermore, at step 1403, the system can construct an extended image for the decoded image frame according to the padding scheme, wherein the extended image comprises one or more padding pixels. Additionally, at step 1404, the system can use the extended image as a reference frame to obtain another decoded image frame.

Many features of the present disclosure can be performed in, using, or with the assistance of hardware, software, firmware, or combinations thereof. Consequently, features of the present disclosure may be implemented using a processing system (e.g., including one or more processors). Exemplary processors can include, without limitation, one or more general purpose microprocessors (for example, single or multi-core processors), application-specific integrated circuits, application-specific instruction-set processors, graphics processing units, physics processing units, digital signal processing units, coprocessors, network processing units, audio processing units, encryption processing units, and the like.

Features of the present disclosure can be implemented in, using, or with the assistance of a computer program product which is a storage medium (media) or computer readable medium (media) having instructions stored thereon/in which can be used to program a processing system to perform any of the features presented herein. The storage medium can include, but is not limited to, any type of disk including floppy disks, optical discs, DVD, CD-ROMs, microdrive, and magneto-optical disks, ROMs, RAMs, EPROMs, EEPROMs, DRAMs, VRAMs, flash memory devices, magnetic or optical cards, nanosystems (including molecular memory ICs), or any type of media or device suitable for storing instructions and/or data.

Stored on any one of the machine readable medium (media), features of the present disclosure can be incorporated in software and/or firmware for controlling the hardware of a processing system, and for enabling a processing system to interact with other mechanism utilizing the results of the present disclosure. Such software or firmware may include, but is not limited to, application code, device drivers, operating systems and execution environments/containers.

Features of the disclosure may also be implemented in hardware using, for example, hardware components such as application specific integrated circuits (ASICs) and field-programmable gate array (FPGA) devices. Implementation of the hardware state machine so as to perform the functions described herein will be apparent to persons skilled in the relevant art.

Additionally, the present disclosure may be conveniently implemented using one or more general purpose or specialized digital computer, computing device, machine, or microprocessor, including one or more processors, memory and/or computer readable storage media programmed according to the teachings of the present disclosure. Appropriate software coding can readily be prepared by skilled programmers based on the teachings of the present disclosure, as will be apparent to those skilled in the software art.

While various embodiments of the present disclosure have been described above, it should be understood that they have been presented by way of example, and not limitation. It will be apparent to persons skilled in the relevant art that various changes in form and detail can be made therein without departing from the spirit and scope of the disclosure.

The present disclosure has been described above with the aid of functional building blocks illustrating the performance of specified functions and relationships thereof. The boundaries of these functional building blocks have often been arbitrarily defined herein for the convenience of the description. Alternate boundaries can be defined so long as the specified functions and relationships thereof are appropriately performed. Any such alternate boundaries are thus within the scope and spirit of the disclosure.

The foregoing description of the present disclosure has been provided for the purposes of illustration and description. It is not intended to be exhaustive or to limit the disclosure to the precise forms disclosed. The breadth and scope of the present disclosure should not be limited by any of the above-described exemplary embodiments. Many modifications and variations will be apparent to the practitioner skilled in the art. The modifications and variations include any relevant combination of the disclosed features. The embodiments were chosen and described in order to best explain the principles of the disclosure and its practical application, thereby enabling others skilled in the art to understand the disclosure for various embodiments and with various modifications that are suited to the particular use contemplated. It is intended that the scope of the invention be defined by the following claims and their equivalence.

What is claimed is:

1. A method for video decoding, comprising:
obtaining a mapping that corresponds a set of image regions in a first decoded image frame to at least a portion of a curved view;
determining a padding scheme for the first decoded image frame based on the mapping;
constructing an extended image for the first decoded image frame according to the padding scheme, wherein the extended image comprises one or more padding pixels; and
using the extended image as a reference frame to obtain a second decoded image frame.

2. The method of claim 1, wherein the second decoded image frame contains another set of image regions associated with at least a portion of another curved view.

3. The method of claim 1, further comprising
storing the extended image in a picture buffer.

4. The method of claim 1, further comprising:
obtaining the first decoded image frame by clipping off the one or more padding pixels from the extended image based on the padding scheme.

5. The method of claim 4, further comprising:
outputting the first decoded image frame for display.

6. The method of claim 1, wherein the mapping is retrieved from decoding information associated with the first decoded image frame.

7. The method of claim 1, further comprising:
obtaining a layout of the set of image regions in the first decoded image frame from decoding information associated with the first decoded image frame.

8. The method of claim 7, wherein the padding scheme is defined based on the layout of the set of image regions in the first decoded image frame.

9. The method of claim 8, wherein the padding scheme includes an indicator for a boundary of one of the image regions in the first decoded image frame, wherein the indicator indicates whether the boundary of the one of the image regions is padded with one or more of the one or more padding pixels.

10. The method of claim 1, further comprising:
identifying one or more reference pixels in the first decoded image frame based on the padding scheme.

11. The method of claim 10, further comprising:
assigning one or more values of the one or more reference pixels to the one or more padding pixels.

12. The method of claim 1, wherein the extended image is a rectangular image containing the set of image regions.

13. The method of claim 12, wherein the one or more padding pixels are arranged
at one or more boundaries of the rectangular image; or
in an area surrounding one or more of the image regions within the rectangular image; or
a combination thereof.

14. The method of claim 1, further comprising:
rendering the at least a portion of the curved view by projecting the set of image regions from a plurality of faces of a polyhedron to a curved surface.

15. The method of claim 14, wherein the curved surface is a spherical surface and the polyhedron is a cube.

16. The method of claim 1, further comprising:
using the one or more padding pixels to perform intra-frame prediction.

17. The method of claim 1, further comprising:
assigning one or more predetermined values to one or more additional padding pixels.

18. The method of claim 17, wherein the one or more additional padding pixels are arranged in one or more corner regions of the extended image.

19. A system for video decoding, comprising:
one or more microprocessors; and
a memory storing instructions that, when executed by the one or more microprocessors, cause the one or more microprocessors to
obtain a mapping that corresponds a set of image regions in a first decoded image frame to at least a portion of a curved view;
determine a padding scheme for the first decoded image frame based on the mapping;
construct an extended image for the first decoded image frame according to the padding scheme, wherein the extended image comprises one or more padding pixels; and
use the extended image as a reference frame to obtain a second decoded image frame.

20. A method for video encoding, comprising:
prescribing a padding scheme based on a mapping that corresponds a set of image regions in an encoding image frame to at least a portion of a curved view;
using the padding scheme to extend the set of image regions with one or more padding pixels; and
using an extended encoding image with the one or more padding pixels to encode the encoding image frame.
